(19) United States
(12) Patent Application Publication
(10) Pub. No.: US 2010/0113296 A1
(43) Pub. Date: May 6, 2010

(54) Methods And Kits For Nucleic Acid Analysis

(76) Inventor: Joel Myerson, Berkeley, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/265,100

(22) Filed: Nov. 5, 2008

(51) Int. Cl. C40B 30/04

(52) U.S. Cl. 506/9

(57) ABSTRACT

Methods for analyzing a mixture of polynucleotides are provided. In some embodiments, a plurality of detection primers comprising target-specific segments complementary to regions in said polynucleotides are employed to generate a library of 3′-end labeled detection primers after hybridization with said mixture of polynucleotides, the detection primers optionally including unique barcode sequences. The labeled detection primers can be enriched and subjected to microarray and/or sequencing analysis. The subject methods can be used, for example, in comparative genomic hybridization, gene expression analysis, methylation analysis, copy-number variation, genome partitioning and other applications. Also provided are kits for use in practicing the subject methods.

### BACKGROUND

DNA microarray technology has revolutionized life-science research. Using arrays, researchers can examine the full complexity of a genome in a single experiment, allowing them to identify and study complex genetic regulatory networks and to begin to understand biology on a genome-wide scale. Arrays have been applied to studies in gene expression, genome mapping, SNP discrimination, transcription factor activity, toxicity, pathogen identification and detection, and many other applications. There is a need for novel techniques and apparatus utilizing arrays.

### SUMMARY

In some embodiments, methods, compositions, and kits for analyzing a target nucleic acid are provided. In some embodiments, a nucleic acid is exposed to a detection primer. In some embodiments, the detection primer comprises a target-specific segment, selected to hybridize to a selected region of interest in the target nucleic acid used in the assay, and an optional unique 5′ barcode sequence. In some embodiments, the detection primer is modified with a label after hybridization to the selected region. The detection primer can be modified in a primer extension reaction. The label can comprise a moiety suitable for detection and/or the label can comprise a capture moiety. The barcode sequence is complementary to an antibarcode probe on a barcode microarray and the labeled primer can be subjected to hybridization and detection by microarray analysis. The labeled detection primer can be subjected to an enrichment procedure prior to microarray analysis.

In some embodiments, a plurality of detection primers can be designed for use in simultaneous analysis of a plurality of different selected regions in one or more target nucleic acids. In some embodiments, each unique primer in the plurality comprises a target-specific segment which can hybridize to a respective complementary region in the target nucleic acid(s). In some embodiments, each unique primer in the plurality comprises a respective unique 5′ barcode sequence. In some embodiments, the primers are modified with a label after hybridization to the respective complementary regions of the template. For example, the plurality of detection primers can be designed for use in a plurality of primer extension reactions after hybridization to the target nucleic acid(s) being assayed. The target-specific segments of the primers can be designed to have similar melting temperatures. The 5′ barcode sequences can be designed to have similar melting temperatures and minimal cross-hybridization. Labeled primers can be subjected to an enrichment procedure prior to microarray analysis. In some embodiments, the labeled primers and/or the target sequences which hybridize with the primers, can be enriched and subjected to sequencing analysis.

Also provided are kits for use in practicing the subject methods. Kits can comprise one or more of the following: a plurality of detection primers as described herein, means for labeling the primers, a microarray comprising a plurality of antibarcode probes for binding to unique barcode sequences in the primers, labeled and unlabeled nucleotides suitable for primer extension, a nucleic acid polymerase suitable for use in a primer extension reaction, and means for enriching labeled primers.

In some embodiments, methods and compositions for generating mixtures of detection primers are provided. In some embodiments, a chemical array of surface immobilized nucleic acids comprising detection primer sequences is subjected to cleavage conditions such that a plurality of nucleic acids is released. The released nucleic acids can be subjected to amplification and further processing, such as restriction digestion, in order to generate a library of detection primers as described herein.

The subject methods and kits find use in a variety of different applications.

### BRIEF DESCRIPTION OF THE FIGURES

FIG. 1 provides a schematic representation of methods of preparing detection primers.

FIG. 2 provides a schematic representation of the use of detection primers showing hybridization and labeling steps.

FIG. 3 provides a schematic representation of some embodiments of labeling steps.

FIG. 4 illustrates some embodiments of methods for array analysis of labeled detection primers.

FIG. 5 illustrates some embodiments of methods for enrichment of labeled detection primers.

FIG. 6 illustrates some embodiments of methods for array analysis of labeled detection primers.

FIG. 7 illustrates some embodiments of methods for producing detection primers.

### DESCRIPTION

As summarized above the present disclosure provides methods of producing and using labeled detection primers in nucleic acid analysis, as well as compositions and kits for use in practicing the subject methods. The subject methods are discussed first in greater detail, followed by a review of representative kits for use in practicing the subject methods.

Before describing the present disclosure in detail, it is to be understood that this disclosure is not limited to specific compositions, method steps, or kits, as such can vary. It is also to be understood that the terminology used herein is for the purpose of describing particular embodiments only, and is not intended to be limiting. Methods recited herein can be carried out in any order of the recited events that is logically possible, as well as the recited order of events. Where a range of values is provided, it is understood that each intervening value, between the upper and lower limit of that range, and any other stated or intervening value in that stated range, is encompassed within the description. The upper and lower limits of these smaller ranges may independently be included in the smaller ranges, and are also encompassed, subject to any specifically excluded limit in the stated range. Where the stated range includes one or both of the limits, ranges excluding either or both of those included limits are also included in the present disclosure. Also, it is contemplated that any optional feature of the disclosed variations described can be set forth and claimed independently, or in combination with any one or more of the features described herein.

All literature and similar materials cited in this application, including but not limited to patents, patent applications, articles, books, treatises, and internet web pages, regardless of the format of such literature and similar materials, are expressly incorporated by reference in their entirety for any purpose. In the event that one or more of the incorporated literature and similar materials differs from or contradicts this application, including but not limited to defined terms, term usage, described techniques, or the like, this application controls.

The publications discussed herein are provided solely for their disclosure prior to the filing date of the present application. Nothing herein is to be construed as an admission that the present disclosure is not entitled to antedate such publication by virtue of prior invention. Further, the dates of publication provided may be different from the actual publication dates, which may need to be independently confirmed.

The practice of the present disclosure will employ, unless otherwise indicated, conventional techniques of synthetic organic chemistry, biochemistry, molecular biology, and the like, which are within the skill of the art. Such techniques are explained fully in the literature.

Unless specifically defined herein, all terms used herein have the same meaning as they would to one skilled in the art of the present disclosure. Practitioners are particularly directed to Sambrook et al. (1989) Molecular Cloning: A Laboratory Manual, 2^{nd} ed., Cold Spring Harbor Press, Plainview, N.Y., and Ausubel et al. (1999) Current Protocols in Molecular Biology (Supplement 47), John Wiley & Sons, New York, for definitions and terms of the art. Various methods, devices and materials similar or equivalent to those described herein can be used in the practice or testing of the disclosed methods.

It must be noted that, as used in the specification and the appended claims, the singular forms “a,” “an” and “the” include plural referents unless the context clearly dictates otherwise. Thus, for example, reference to “a solid support” includes a plurality of solid supports. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

In this specification and in the claims that follow, reference will be made to a number of terms that shall be defined to have the following meanings unless a contrary intention is apparent.

The term “nucleic acid” as used herein means a polymer composed of nucleotides, e.g. deoxyribonucleotides or ribonucleotides, or compounds produced synthetically (e.g. PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

“Polynucleotide” or “oligonucleotide” are used interchangeably and each mean a linear polymer of nucleotide monomers. Monomers making up polynucleotides and oligonucleotides are capable of specifically binding to a natural polynucleotide by way of a regular pattern of monomer-to-monomer interactions, such as Watson-Crick type of base pairing, base stacking, Hoogsteen or reverse Hoogsteen types of base pairing, or the like. Such monomers and their internucleosidic linkages may be naturally occurring or may be analogs thereof, e.g. naturally occurring or non-naturally occurring analogs. Non-naturally occurring analogs may include PNAs, phosphorothioate internucleosidic linkages, bases containing linking groups permitting the attachment of labels, such as fluorophores, or haptens, and the like. Whenever the use of an oligonucleotide or polynucleotide requires enzymatic processing, such as extension by a polymerase, ligation by a ligase, or the like, one of ordinary skill would understand that oligonucleotides or polynucleotides in those instances would not contain certain analogs of internucleosidic linkages, sugar moities, or bases at any or some positions. Polynucleotides typically range in size from a few monomeric units, e.g. 5-200, when they are usually referred to as “oligonucleotides,” to several thousand monomeric units. Whenever a polynucleotide or oligonucleotide is represented by a sequence of letters (upper or lower case), such as “ATGCCTG,” it will be understood that the nucleotides are in 5′→3′ order from left to right and that “A” denotes deoxyadenosine, “C” denotes deoxycytidine, “G” denotes deoxyguanosine, and “T” denotes thymidine, “I” denotes deoxyinosine, “U” denotes uridine, unless otherwise indicated or obvious from context. Unless otherwise noted the terminology and atom numbering conventions will follow those disclosed in Strachan and Read, Human Molecular Genetics 2 (Wiley-Liss, New York, 1999). Usually polynucleotides comprise the four natural nucleosides (e.g. deoxyadenosine, deoxycytidine, deoxyguanosine, deoxythymidine for DNA or their ribose counterparts for RNA) linked by phosphodiester linkages; however, they may also comprise non-natural nucleotide analogs, e.g. including modified bases, sugars, or internucleosidic linkages. It is clear to those skilled in the art that where an enzyme has specific oligonucleotide or polynucleotide substrate requirements for activity, e.g. single stranded DNA, RNA/DNA duplex, or the like, then selection of appropriate composition for the oligonucleotide or polynucleotide substrates is well within the knowledge of one of ordinary skill, especially with guidance from treatises, such as Sambrook et al. (1989), and like references.

The terms “nucleoside” and “nucleotide” are intended to include those moieties which contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

The term “functionalization” as used herein relates to modification of a solid substrate to provide a plurality of functional groups on the substrate surface. By a “functionalized surface” as used herein is meant a substrate surface that has been modified so that a plurality of functional groups are present thereon.

The terms “reactive site”, “reactive functional group” or “reactive group” refer to moieties on a monomer, polymer or substrate surface that may be used as the starting point in a synthetic organic process. This is contrasted to “inert” hydrophilic groups that could also be present on a substrate surface, e.g., hydrophilic sites associated with polyethylene glycol, a polyamide or the like.

The phrase “oligonucleotide bound to a surface of a solid support” refers to an oligonucleotide or mimetic thereof, e.g., PNA, that is immobilized on a surface of a solid substrate in a feature or spot, where the substrate can have a variety of configurations, e.g., a sheet, bead, or other structure. In some embodiments, the collections of features of oligonucleotides employed herein are present on a surface of the same planar support, e.g., in the form of an array.

The term “array” encompasses the term “microarray” and refers to an ordered array presented for binding to nucleic acids and the like. Arrays, as described in greater detail below, are generally made up of a plurality of distinct or different features. The term “feature” is used interchangeably herein with the terms: “features,” “feature elements,” “spots,” “addressable regions,” “regions of different moieties,” “surface or substrate immobilized elements” and “array elements,” where each feature is made up of oligonucleotides bound to a surface of a solid support, also referred to as substrate immobilized nucleic acids.

An “array” includes any one-dimensional, two-dimensional or substantially two-dimensional (as well as a three-dimensional) arrangement of addressable regions (i.e., features, e.g., in the form of spots) bearing nucleic acids, particularly oligonucleotides or synthetic mimetics thereof (i.e., the oligonucleotides defined above), and the like. Where the arrays are arrays of nucleic acids, the nucleic acids may be adsorbed, physisorbed, chemisorbed, or covalently attached to the arrays at any point or points along the nucleic acid chain.

Any given substrate may carry one, two, four or more arrays disposed on a front surface of the substrate. Depending upon the use, any or all of the arrays may be the same or different from one another and each may contain multiple spots or features. A typical array may contain one or more, including more than two, more than ten, more than one hundred, more than one thousand, more ten thousand features, more than one hundred thousand features, or more than one million features, in an area of less than 20 cm² or even less than 10 cm², e.g., less than about 5 cm², including less than about 1 cm², less than about 1 mm², e.g., 100 μ², or even smaller. For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, 20%, 50%, 95%, 99% or 100% of the total number of features). Inter-feature areas will typically (but not essentially) be present which do not carry any nucleic acids (or other biopolymer or chemical moiety of a type of which the features are composed). Such inter-feature areas typically will be present where the arrays are formed by processes involving drop deposition of reagents but may not be present when, for example, photolithographic array fabrication processes are used. It will be appreciated though, that the inter-feature areas, when present, could be of various sizes and configurations.

In some embodiments, each array may cover an area of less than 200 cm², or even less than 50 cm², 5 cm², 1 cm², 0.5 cm², or 0.1 cm². In some embodiments, the substrate carrying the one or more arrays will be shaped generally as a rectangular solid (although other shapes are possible), having a length of more than 4 mm and less than 150 mm, usually more than 4 mm and less than 80 mm, more usually less than 20 mm; a width of more than 4 mm and less than 150 mm, usually less than 80 mm and more usually less than 20 mm; and a thickness of more than 0.01 mm and less than 5.0 mm, usually more than 0.1 mm and less than 2 mm and more usually more than 0.2 and less than 1.5 mm, such as more than about 0.8 mm and less than about 1.2 mm. With arrays that are read by detecting fluorescence, the substrate may be of a material that emits low fluorescence upon illumination with the excitation light. The substrate may be relatively transparent to reduce the absorption of the incident illuminating laser light and subsequent heating if the focused laser beam travels too slowly over a region. For example, the substrate may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays can be fabricated using drop deposition from pulse-jets of either polynucleotide precursor units (such as monomers) in the case of in situ fabrication, or the previously obtained polynucleotide. Such methods are described in detail in, for example, the previously cited references including U.S. Pat. No. 6,323,043, U.S. Pat. No. 6,242,266, U.S. Pat. No. 6,232,072, U.S. Pat. No. 6,180,351, U.S. Pat. No. 6,171,797, U.S. patent application Ser. No. 09/302,898 filed Apr. 30, 1999 by Caren et al., and the references cited therein. Instead of drop deposition methods, photolithographic array fabrication methods may be used (see, e.g., U.S. Pat. No. 5,599,695, U.S. Pat. No. 5,753,788, and U.S. Pat. No. 6,329,143) or micromirror fabrication methods (e.g., as available from Roche/NimbleGen and as described in U.S. published application no. 20030054388) may be used. Interfeature areas need not be present particularly when the arrays are made by photolithographic methods as described in those patents.

In some embodiments, in situ prepared arrays are employed. In situ prepared oligonucleotide arrays, e.g., nucleic acid arrays, may be characterized by having surface properties of the substrate that differ significantly between the feature and inter-feature areas. Specifically, such arrays may have high surface energy, hydrophilic features and hydrophobic, low surface energy hydrophobic interfeature regions. Whether a given region, e.g., feature or interfeature region, of a substrate has a high or low surface energy can be readily determined by determining the region's “contact angle” with water, as known in the art and further described in U.S. patent application Ser. No. 10/449,838, the disclosure of which is herein incorporated by reference. Other features of in situ prepared arrays that make such array formats of particular interest in some embodiments of the present invention include, but are not limited to: feature density, oligonucleotide density within each feature, feature uniformity, low intra-feature background, low inter-feature background, e.g., due to hydrophobic interfeature regions, fidelity of oligonucleotide elements making up the individual features, array/feature reproducibility, and the like. The above benefits of in situ produced arrays assist in maintaining adequate sensitivity while operating under stringency conditions required to accommodate highly complex samples.

In selecting probes, it can be useful to use a computational algorithm to produce a calculated melting temperature for each probe. Sets of probe that have a narrow melting temperature range may be particularly suited for some applications of array hybridization analysis. A nearest neighbor analysis that adjusts for mismatches in the probe sequences can be used to generate the calculated melting temperatures. In some embodiments with no mismatches, a simpler nearest neighbor algorithm can be used. Software methods for calculating melting temperatures are well developed, and such may be obtained from various commercial or academic sources. Some commercial sources for software include Alkami Biosystems, Molecular Biology Insights, PREMIER Biosoft International, IntelliGenetics Inc., Hitachi Inc., DNA Star, Advanced American Biotechnology and Imaging. Various references have described melting temperature calculations, including Breslauer et al. (1986) Proc Natl Acad Sci. 83:3746-3750; Sugimoto et al. (1996) Nucleic Acids Research 24:4501; Xia et al. (1998) Biochemistry 37:14719-35.

Probes may be selected, e.g. based on sequence, GC content, AT content, or based on empirical performance in use, or based on other appropriate factors. In some embodiments, the calculated melting temperatures of at least about 80% of the probes on an array fall within a range of about 6 degrees Celsius. In some embodiments, the calculated melting temperature of each probe is obtained using a nearest neighbor analysis algorithm and the template sequence that the probe is directed to, and may include any insertions, deletions, or substitutions. It is further noted that the particular methodology used to select probe sets is illustrative only, and should not be interpreted to limit the scope of the disclosure.

A “scan region” refers to a contiguous (preferably, rectangular) area in which the array spots or features of interest, as defined above, are found. The scan region is that portion of the total area illuminated from which the resulting fluorescence is detected and recorded. In some embodiments, the scan region includes the entire area of the slide scanned in each pass of the lens, between the first feature of interest, and the last feature of interest, even if there exist intervening areas which lack features of interest. An “array layout” refers to one or more characteristics of the features, such as feature positioning on the substrate, one or more feature dimensions, and an indication of a moiety at a given location.

An array “package” may be the array plus only a substrate on which the array is deposited, although the package may include other features (such as a housing with a chamber). A “chamber” references an enclosed volume (although a chamber may be accessible through one or more ports). It will also be appreciated that throughout the present disclosure, that words such as “top,” “upper,” and “lower” are used in a relative sense only.

The term “simultaneously” means that more than one reaction occur at substantially the same time.

“Hybridizing” and “binding”, with respect to polynucleotides, are used interchangeably.

Generally, nucleic acid hybridizations comprise the following major steps: (1) immobilization of probe nucleic acids; (2) prehybridization treatment to increase accessibility of target DNA, and to reduce nonspecific binding; (3) hybridization of the mixture of nucleic acid targets to the nucleic acid on the solid surface; (4) posthybridization washes to remove nucleic acid fragments not bound in the hybridization and (5) detection of the hybridized nucleic acid fragments. The reagent used in each of these steps and their conditions for use vary depending on the particular application.

Array hybridization is carried out under suitable hybridization conditions, which may vary in stringency as desired. In some embodiments, highly stringent hybridization conditions may be employed. The array hybridization step may include agitation of the immobilized features and the sample of solution phase labeled primers, where the agitation may be accomplished using any convenient protocol, e.g., shaking, rotating, spinning, and the like.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

As known in the art, “stringent hybridization conditions” and “stringent hybridization wash conditions” in the context of nucleic acid hybridization are sequence dependent, and are different under different experimental parameters. Stringent hybridization conditions include, but are not limited to, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization in 0.5 M NaHPO₄, 7% sodium dodecyl sulfate (SDS), 1 mM EDTA at 65° C., and washing in 0.1×SSC/0.1% SDS at 68° C. can be performed. In some embodiments, stringent hybridization conditions include hybridization at 60° C. or higher and 3×SSC (450 mM sodium chloride/45 mM sodium citrate) or incubation at 42° C. in a solution containing 30% formamide, 1 M NaCl, 0.5% sodium sarcosine, 50 mM MES, pH 6.5. Those of ordinary skill will readily recognize that alternative but comparable hybridization and wash conditions can be utilized to provide conditions of similar stringency.

In some embodiments, the stringency of the wash conditions set forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

Some embodiments of stringent assay conditions comprise rotating hybridization at 65° C. in a salt based hybridization buffer with a total monovalent cation concentration of 1.5 M (e.g., as described in U.S. patent application Ser. No. 09/655,482) followed by washes of 0.5×SSC and 0.1×SSC at room temperature.

Stringent assay conditions include hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

“Primer” means an oligonucleotide, either natural or synthetic, that is capable, upon forming a duplex with a polynucleotide template, of acting as a point of initiation of nucleic acid synthesis and being extended from its 3′ end along the template so that an extended duplex is formed. The sequence of nucleotides added during the extension process are determined by the sequence of the template polynucleotide. Usually primers are extended by a DNA polymerase. Primers can have any suitable length, and can range, for example, from 10 to 500 or from 20-200 nucleotides.

“Primer extension” is the enzymatic addition, i.e., polymerization, of monomeric nucleotide units to a primer while the primer is hybridized (annealed) to a template polynucleotide. Primer extension is initiated at the template site where a primer anneals.

The term “target-specific segment” refers to a sequence within a detection primer capable of hybridizing with its corresponding complementary region in a template, to the exclusion of other non-complementary sequences. Under appropriate conditions, the hybridized primer can prime primer extension.

The term “mixture”, as used herein, refers to a combination of elements, that are interspersed and not in any particular order. A mixture is heterogeneous and not spatially separable into its different constituents. Examples of mixtures of elements include a number of different elements that are dissolved in the same aqueous solution, or a number of different elements attached to a solid support at random or in no particular order in which the different elements are not especially distinct. In other words, a mixture is not addressable. To be specific, an array of surface bound polynucleotides, as is commonly known in the art and described herein, is not a mixture of capture agents because the species of surface bound polynucleotides are spatially distinct and the array is addressable.

“Isolated” or “purified” generally refers to isolation of a substance (compound, polynucleotide, protein, polypeptide, polypeptide, chromosome, etc.) such that the substance comprises the majority percent of the sample in which it resides. Typically in a sample a substantially purified component comprises 50%, preferably 80%-85%, more preferably 90-95% of the sample. Techniques for purifying polynucleotides and polypeptides of interest are well known in the art and include, for example, ion-exchange chromatography, affinity chromatography, flow sorting, and sedimentation according to density.

The term “sample” as used herein relates to a material or mixture of materials, typically, although not necessarily, in fluid form, containing one or more components of interest.

“Complementary” references a property of specific binding between polynucleotides based on the sequences of the polynucleotides. Portions of polynucleotides are complementary to each other if they follow conventional base-pairing rules, e.g. A pairs with T (or U) and G pairs with C. “Complementary” includes embodiments in which there is an absolute sequence complementarity, and also embodiments in which there is a substantial sequence complementarity. “Absolute sequence complementarity” means that there is 100% sequence complementarity between a first polynucleotide and a second polynucleotide, i.e. there are no insertions, deletions, or substitutions in either of the first and second polynucleotides with respect to the other polynucleotide (over the complementary region). Put another way, every base of the complementary region may be paired with its complementary base, i.e. following normal base-pairing rules. “Substantial sequence complementarity” permits one or more relatively small (less than 10 bases, e.g. less than 5 bases, typically less than 3 bases, more typically a single base) insertions, deletions, or substitutions in the first and/or second polynucleotide (over the complementary region) relative to the other polynucleotide. The region that is complementary between a first polynucleotide and a second polynucleotide (e.g. a target and a probe) is typically at least about 10 bases long, at least about 15 bases long, at least about 20 bases long, or at least about 25 bases long. The region that is complementary between a first polynucleotide and a second polynucleotide (e.g. target and a probe) may be up to about 200 bases long, or more typically up to about 120 bases long, more typically up to about 100 bases long, still more typically up to about 80 bases long, yet more typically up to about 60 bases long, more typically up to about 45 bases long.

“Upstream” as used herein refers to the 5′ direction along the template. “Downstream” refers to the 3′ direction along the template. Hence, a primer binding downstream of a particular site is located at (or is complementary to) a sequence of the template that is in the 3′ direction from the particular site along the template.

Following hybridization and washing, as described above, the hybridization of the labeled primers to the probes can be detected using standard techniques so that the surface of immobilized probes, e.g., the array, is interrogated, or read. Reading the resultant hybridized array may be accomplished by illuminating the array and reading the location and intensity of resulting fluorescence at each feature of the array to detect any binding complexes on the surface of the array. For example, a scanner may be used for this purpose, which is similar to the AGILENT MICROARRAY SCANNER available from Agilent Technologies, Palo Alto, Calif. Other suitable devices and methods are described in U.S. Pat. Nos. 7,205,553 and 6,406,849. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). In the case of indirect labeling, subsequent treatment of the array with the appropriate reagents may be employed to enable reading of the array. Some methods of detection, such as surface plasmon resonance, do not require any labeling of nucleic acids, and are suitable for some embodiments.

Results from the reading or evaluating may be raw results (such as fluorescence intensity readings for each feature in one or more color channels) or may be processed results (such as those obtained by subtracting a background measurement, or by rejecting a reading for a feature which is below a predetermined threshold, normalizing the results) and/or forming conclusions based on the pattern read from the array.

In some embodiments, results from interrogating the array are used to assess the level of binding of the population of labeled detection primers to probes on the array. The term “level of binding” means any assessment of binding (e.g. a quantitative or qualitative, relative or absolute assessment) usually done, as is known in the art, by detecting signal (i.e., pixel brightness) from a label associated with an olligonucleotide primer. The level of binding of labeled primers to probe is typically obtained by measuring the surface density of the bound label (or of a signal resulting from the label).

By “remote location,” it is meant a location other than the location at which the array is present and hybridization occurs. For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart. “Communicating” information references transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data.

In some embodiments, the subject methods include a step of transmitting data or results from at least one of the detecting and deriving steps, also referred to herein as evaluating, as described above, to a remote location. By “remote location” is meant a location other than the location at which the array is present and hybridization occur. For example, a remote location could be another location (e.g. office, lab, etc.) in the same city, another location in a different city, another location in a different state, another location in a different country, etc. As such, when one item is indicated as being “remote” from another, what is meant is that the two items are at least in different buildings, and may be at least one mile, ten miles, or at least one hundred miles apart.

“Communicating” information means transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data. The data may be transmitted to the remote location for further evaluation and/or use. Any convenient telecommunications means may be employed for transmitting the data, e.g., facsimile, modem, internet, etc.

The term “assessing” and “evaluating” are used interchangeably to refer to any form of measurement, and includes determining if an element is present or not. The terms “determining,” “measuring,” and “assessing,” and “assaying” are used interchangeably and include either or both of quantitative and qualitative determinations. Assessing may be relative or absolute. “Assessing the presence of” includes determining the amount of something present, as well as determining whether it is present or absent.

“Sensitivity” is a term used to refer to the ability of a given assay to detect a given analyte in a sample, e.g., a nucleic acid species of interest. For example, an assay has high sensitivity if it can detect a small concentration of analyte molecules in sample. Conversely, a given assay has low sensitivity if it only detects a large concentration of analyte molecules (i.e., specific solution phase nucleic acids of interest) in sample. A given assay's sensitivity is dependent on a number of parameters, including specificity of the reagents employed (e.g., types of labels, types of binding molecules, etc.), assay conditions employed, detection protocols employed, and the like. In the context of array hybridization assays, such as those of the present invention, sensitivity of a given assay may be dependent upon one or more of: the nature of the surface immobilized nucleic acids, the nature of the hybridization and wash conditions, the nature of the detection primer, the nature of the labeling system, the nature of the detection system, etc.

“Template” references a polynucleotide comprising DNA, cDNA, or RNA. A template obtained for various analyses such as gene expression, methylation, copy-number variation, location analysis, SNP analysis, and other analytical methods. The nucleic acid template can be prepared using conventional protocols which can include, for example, steps such as cross-linking, cell fractionation, fragmentation, immuno-precipitation, and chromatographic separation.

In some embodiments, the template comprises genomic DNA. The term “genome” refers to all nucleic acid sequences (coding and non-coding) and elements present in or originating from any virus, single cell (prokaryote and eukaryote) or each cell type and their organelles (e.g. mitochondria) in a metazoan organism. The term genome also applies to any naturally occurring or induced variation of these sequences that may be present in a mutant or disease variant of any virus or cell type. These sequences include, but are not limited to, those involved in the maintenance, replication, segregation, and higher order structures (e.g. folding and compaction of DNA in chromatin and chromosomes), or other functions, if any, of the nucleic acids as well as all the coding regions and their corresponding regulatory elements needed to produce and maintain each particle, cell or cell type in a given organism.

For example, the human genome consists of approximately 3×10⁹ base pairs of DNA organized into distinct chromosomes. The genome of a normal diploid somatic human cell consists of 22 pairs of autosomes (chromosomes 1 to 22) and either chromosomes X and Y (males) or a pair of chromosome Xs (female) for a total of 46 chromosomes. A genome of a cancer cell may contain variable numbers of each chromosome in addition to deletions, rearrangements and amplification of any subchromosomal region or DNA sequence.

By “genomic source” is meant the initial nucleic acids that are used as the original nucleic acid source from which labeled detection primers are produced, e.g., as a template in some embodiments of the present labeling methods.

The genomic source may be prepared using any convenient protocol. In many embodiments, the genomic source is prepared by first obtaining a starting composition of genomic DNA, e.g., a nuclear fraction of a cell lysate, where any convenient means for obtaining such a fraction may be employed and numerous protocols for doing so are well known in the art. The genomic source is, in some embodiments of interest, genomic DNA representing the entire genome from a particular organism, tissue or cell type. However, in some embodiments the genomic source may comprise a portion of the genome, e.g., one or more specific chromosomes or regions thereof, such as PCR amplified regions produced with a pairs of specific primers.

A given initial genomic source may be prepared from a subject, for example a plant or an animal, which subject is suspected of being homozygous or heterozygous for a deletion or amplification of a genomic region. In some embodiments, the average size of the constituent molecules that make up the initial genomic source typically have an average size of at least about 1 Mb, where a representative range of sizes is from about 50 to about 250 Mb or more, while in some embodiments, the sizes may not exceed about 1 MB, such that they may be about 1 Mb or smaller, e.g., less than about 500 Kb, etc.

In some embodiments, the genomic source is “mammalian”, where this term is used broadly to describe organisms which are within the class mammalia, including the orders carnivore (e.g., dogs and cats), rodentia (e.g., mice, guinea pigs, and rats), and primates (e.g., humans, chimpanzees, and monkeys), where of particular interest in some embodiments are human or mouse genomic sources. In some embodiments, a set of nucleic acid sequences within the genomic source is complex, as the genome contains at least about 1×10⁸ base pairs, including at least about 1×10⁹ base pairs, e.g., about 3'10⁹ base pairs.

Where desired, an initial genomic source may be fragmented, as desired, to produce a fragmented genomic source, where the molecules have a desired average size range, e.g., up to about 10 Kb, such as up to about 1 Kb, where fragmentation may be achieved using any convenient protocol, including but not limited to: mechanical protocols, e.g., sonication, shearing, etc., chemical protocols, e.g., enzyme digestion, etc.

Where desired, an initial genomic source may be amplified as part of a template generation protocol, where the amplification may or may not occur prior to any fragmentation step.

Following provision of the initial genomic source, and any initial processing steps (e.g., fragmentation, amplification, etc.), the collection of solution phase template can be prepared for use in the subject methods.

### Methods

In some embodiments, there are provided methods for generating labeled detection primers from a nucleic acid template, where a feature of the subject methods is the use of a detection primer in a primer extension protocol.

In practicing some embodiments of the subject methods, an initial step is to provide a nucleic acid template. By nucleic acid template is meant the nucleic acids that are used as template in the primer labeling reactions as described herein. In some embodiments, the nucleic acid template is a population of deoxyribonucleic acid or ribonucleic acid molecules, whereby population is meant a collection of molecules in which at least two constituent members have nucleotide sequences that differ from each other, e.g., by at least about 1 basepair, by at least about 5 basepairs, by at least about 10 basepairs, by at least about 50 base pairs, by at least about 100 base pairs, by at least about 1 kb, by at least about 10 kb etc.

The nucleic acid template can be prepared using any convenient procedure. In some embodiments, polynucleotide template may be prepared from a subject, for example a plant or an animal, that is suspected of being homozygous or heterozygous for a deletion or amplification of a genomic region. In some embodiments, the average size of the constituent molecules that make up the template do not exceed about 10 kb in length, typically do not exceed about 8 kb in length and sometimes do not exceed about 5 kb in length, such that the average length of molecules in a given genomic template composition may range from about 1 kb to about 10 kb, usually from about 5 kb to about 8 kb in some embodiments. The template may be prepared from an initial chromosomal source by fragmenting the source into the template having molecules of the desired size range, where fragmentation may be achieved using any convenient protocol, including but not limited to: mechanical protocols, e.g., sonication, shearing, etc., chemical protocols, e.g., enzyme digestion, etc.

Following sample preparation, the template nucleic acid molecules are employed in the preparation of labeled detection primers in a protocol in which at least one primer, and often a mixture of different primers, are employed.

Labeling methods utilizing “random” primers have been described. (See, e.g., U.S. Pat. No. 7,011,949; and U.S. Pat. Publication No. 20040191813. Such methods are non-selective in the template DNA that is bound by the primers. Labeled targets are generated that are not represented by compliment probes on the microarray, thus adding to noise in the detected signal due to cross-hybridization. Only a small percentage of the labeled target material actually hybridizes to the immobilize probes, which results in low signal intensities for genomic derived target nucleic acid populations. In addition, the use of random primer in the labeling protocol can generate complimentary target strands which can subsequently hybridize together rendering them insufficient for binding to their cognate array probe. Thus, the high complexity of the labeled target can result in increased noise and decreased probe signal on the microarry.

In contrast, the present methods do not use random primers. From the knowledge of the sequence of the template nucleic acids, detection primers can be designed to include have target-specific segments complementary to essentially any desired sequence in the template nucleic acid molecule.

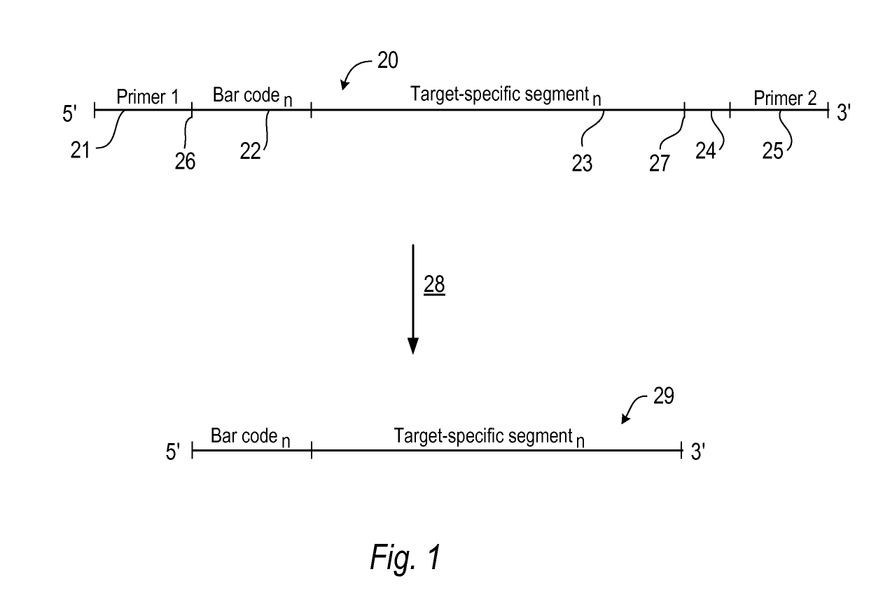

Some embodiments of the present methods are illustrated in FIG. 1 which shows a representative oligonucleotide 20 in an oligonucleotide library prepared as described herein. Oligonucleotide 20 includes a unique sequence 23, and a corresponding unique barcode sequence 22. An oligonucleotide library can include any desired number of members, n, wherein n can be 10, 100, 1000, 10⁷, or more. In some embodiments, an oligonucleotide library comprises 10⁴ to 10⁷ members. Oligonucleotide 20 can be amplified by any suitable conventional amplification method using amplification primer binding sequence 21 and amplification primer binding sequence 25. In some embodiments, both amplification primer binding sequence 21 and amplification primer binding sequence 25 are identical. Oligonucleotide 20 can also include cleavage motif 24 and cleavage site 27, and optionally can include cleavage site 26. In step 28, oligonucleotide 20 is subjected to restriction digestion, and single-stranded detection primers, as exemplified by primer 29, are isolated. Multiple detection primers containing different target specific segments may be simultaneously amplified by incorporating the same amplification primer binding sequences in each.

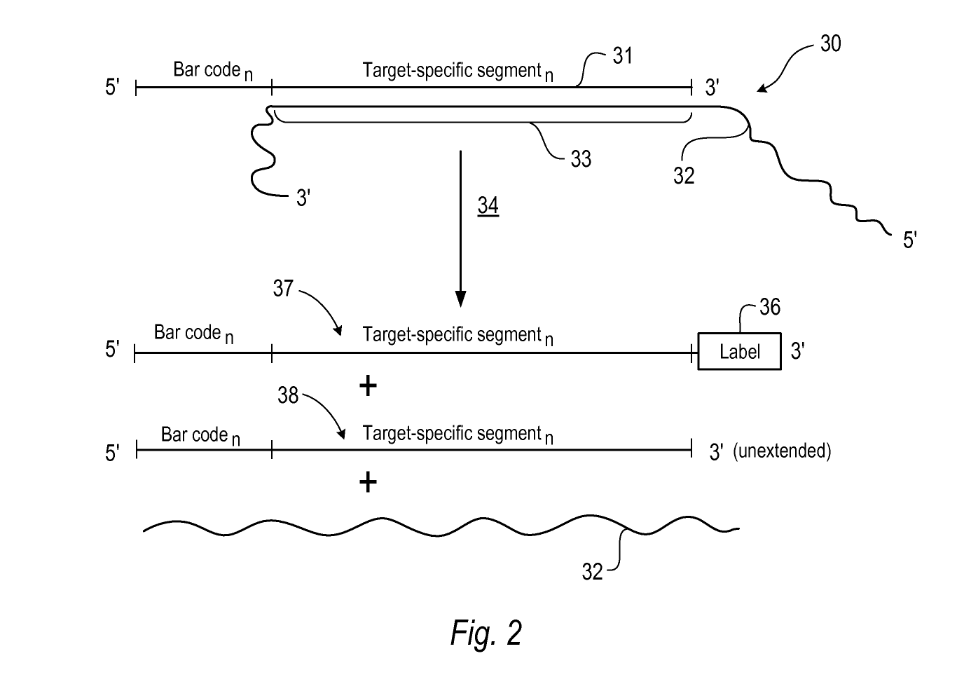

In FIG. 2, a target-specific segment 31 in detection primer 29, is annealed to a sample nucleic acid template 32 at complementary region 33 and enzymatically extended at step 34 to form primer 37 comprising label 36. In some embodiments, primer 29 is in excess over the amount of template 32, and in some embodiments, some primer 29 remains unlabeled at 38. Some of primer 29 may remain unlabeled if it is in excess, or if the labeling reaction does not use up all of primer 29. If the template lacks region 33, then the primer for that region would not be labeled. Extended detection primer 37 can be released from template 32 by exposure to any suitable conventional denaturation procedure, such as thermal denaturation.

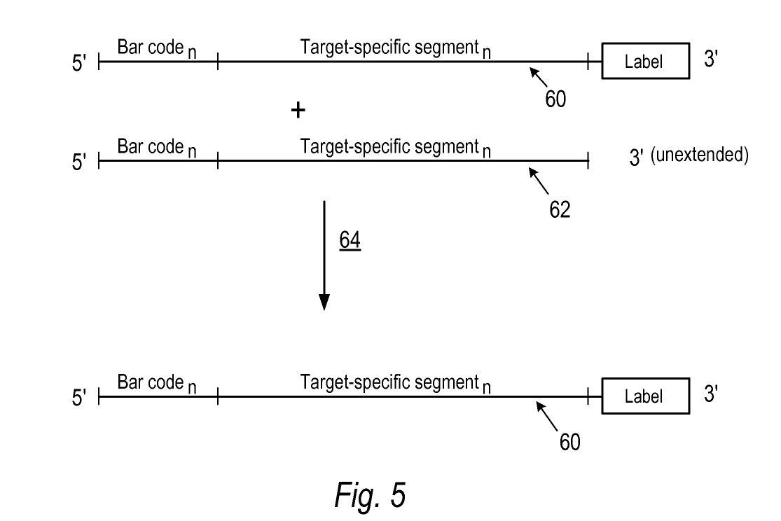

In some embodiments (FIG. 5), a mixture of labeled primers 60 and unlabeled primers 62 are subjected to exonuclease digestion (e.g. with Exonuclease I) wherein 3′ labeled nucleic acids (60), are not cleaved.

In some embodiments, the labeled primers are subjected to microarray analysis as described below. In some embodiments, labeled primers may be enriched by affinity methods, and may be subjected to sequencing protocols. Any suitable sequencing protocol may be used, and may include linear analysis technologies, including single molecule methods such as scanning probe microscopy, chemical force microscopy, molecular motors, mass spectral analysis and the like (see, e.g., published application no. PCT/US98/03024; U.S. patent application Ser. No. 09/134,411; U.S. Pat. Nos. 6,225,062; 6,210,896; 6,436,635; 7,008,766; and 7,163,658). Labeled detection primers may also be used in genome partitioning protocols (see, e.g., WO/2004/022758) to reduce the complexity of a nucleic acid sample prior to sequencing. Various methods for sequencing are commercially available, and include the Genome Sequencer FLX™ System, (Roche, 454 Life Sciences), Solexa™ Sequencing Technology (Illumnia), and SOLID™ Analyzer (Applied Biosystems).

The detection primers described above and throughout this specification may be labeled using any suitable method, including primer extension. In some embodiments, the detection primers are labeled with a detectable label. A number of different nucleic acid labeling protocols are known in the art and may be employed to produce a population of labeled detection primers. The particular protocol may include the use of labeled nucleotides, or modified nucleotides that can be conjugated with different dyes.

In one type of representative labeling protocol of interest, the initial nucleic acid source, which most often is fragmented, is employed in the preparation of labeled primers in template-dependent extension. “Template-dependent extension” refers to a process of extending a primer on a template nucleic acid that produces an extension product, i.e. an oligonucleotide that comprises the primer plus one or more nucleotides, that is complementary to the template nucleic acid. Template-dependent extension may be carried out several ways, including chemical ligation, enzymatic ligation, enzymatic polymerization, or the like. Enzymatic extensions are preferred because the requirement for enzymatic recognition increases the specificity of the reaction.

In template-dependent extension, the primer is contacted with the template under conditions sufficient to extend the primer and produce a primer extension product. In some embodiments, the primer extension is performed in a non-amplifying manner in which essentially a single product is produced per template strand. The detection primers can be contacted with the template in the presence of a sufficient DNA polymerase under primer extension conditions sufficient to produce the desired primer extension molecules. DNA polymerases of interest include, but are not limited to, polymerases derived from E. coli, thermophilic bacteria, archaebacteria, phage, yeasts, Neurosporas, Drosophilas, primates and rodents. The DNA polymerase extends the primer according to the genomic template to which it is hybridized in the presence of additional reagents which may include, but are not limited to: labeled dNTPs, dNTPs; monovalent and divalent cations, e.g. KCl, MgCl₂; sulfhydryl reagents, e.g. dithiothreitol; and buffering agents, e.g. Tris-Cl.

In some embodiments, the reagents employed in the primer extension reactions can include a labeling reagent, where the labeling reagent may be the primer or a labeled nucleotide, which may be labeled with a directly or indirectly detectable label. A directly detectable label is one that can be directly detected without the use of additional reagents, while an indirectly detectable label is one that is detectable by employing one or more additional reagent, e.g., where the label is a member of a signal producing system made up of two or more components. In some embodiments, the label is a directly detectable label, such as a fluorescent label, where the labeling reagent employed in such embodiments is a fluorescently labeled nucleotide(s), e.g., dCTP. Fluorescent moieties which may be used to label nucleotides for producing labeled nucleic acids include, but are not limited to: fluorescein, the cyanine dyes, such as Cy3, Cy5, Alexa 555, Bodipy 630/650, and the like. Other labels may also be employed as are known in the art.

In some embodiments, the detection primers may be modified by labeling with an affinity moiety (affinity tag) and/or a detector moiety (e.g., fluorophore or enzyme). In some embodiments, the labeling products will comprise an affinity moiety, and the nucleic acid product or products can be purified using the affinity moiety. Suitable affinity moieties are exemplified by biotin, avidin and streptavidin or naturally or synthetic variants or homologs thereof.

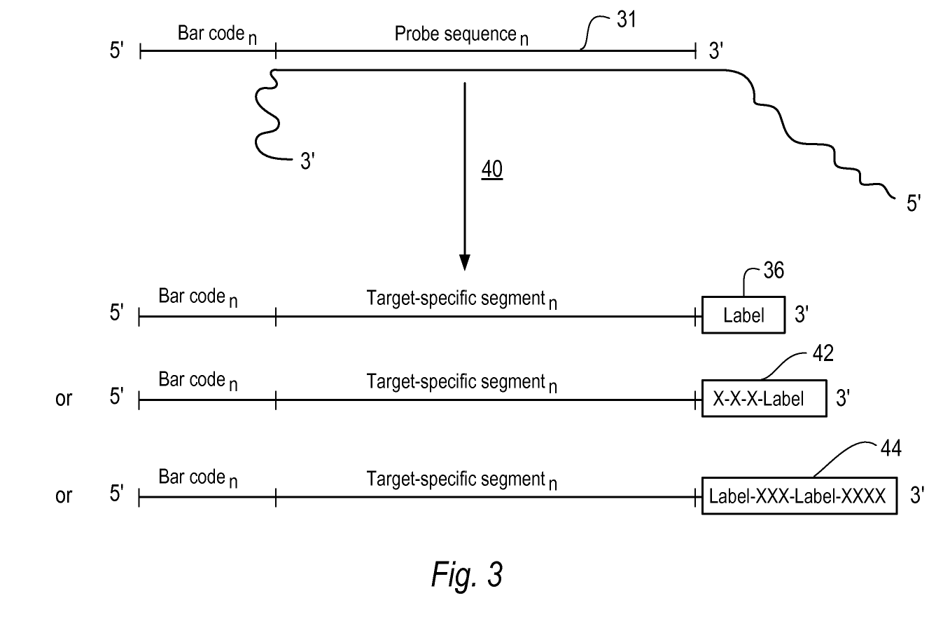

In some embodiments, primer extension reactions can include all four labeled dideoxyNTPs (ddNTPs), a single labeled dideoxy NTP and three unlabeled dNTPs, or an appropriate combination of labeled ddNTPs and unlabeled dNTPs. It is possible to incorporate more than one label if labeled dNTP is used, and ddNTP terminators are not present, or are present in a mixture of dNTPs. Different colored labels may be used for identifying different primers or different groups of primers. In some embodiments, different labels could be used to analyze templates from test and control samples. Some embodiments of labeled extension products are shown as 36, 42 and 44 (FIG. 3) were “X” represents a non-labeled nucleotide, and “Label” refers to a labeled nucleotide.

In some embodiments, detection primers are extended with αS-dNTPs or αS-ddNTPs which create oligonulceotides with phosphorothioates at the 3′-end. (see, e.g., Nakamaye (1988) Nucleic Acids Res. 16:9947-59). These nucleotides may comprise a pre-incorporated label, or the sulfur can be selectively reacted with a labeling reagent added after extension (see, e.g., Fidenza (1989) J. Am. Chem. Soc. 111:9117). Such phosphorothioate containing oligonucleotides are known to be resistant to exonuclease digestion, so the extended detection primers will survive a digestion protocol such as indicated above (FIG. 5).

In some embodiments of primer extension reactions, the template can be first subjected to strand disassociation conditions, e.g., subjected to a temperature ranging from about 80° C. to about 100° C., usually from about 90° C. to about 95° C. for a period of time, and the resultant disassociated template molecules are then contacted with the primer molecules under annealing conditions, where the temperature of the template and primer composition is reduced to an annealing temperature of from about 20° C. to about 80° C., usually from about 37° C. to about 65° C. In some embodiments, a “snap-cooling” protocol is employed, where the temperature is reduced to the annealing temperature, or to about 4° C. or below in a period of from about 1 s to about 30 s, usually from about 5 s to about 10 s.

The above protocol results in the production of labeled detection primers. Where desired, the resultant produced labeled primers may be separated from the remainder of the reaction mixture, where any convenient separation protocol may be employed.

FIG. 3 illustrates some embodiments of a labeling step 40. In label 42, additional unlabeled nucleotide bases are incorporated along with a single label. In label 44, a plurality of detectable moieties are incorporated along with unlabeled nucleotide bases.

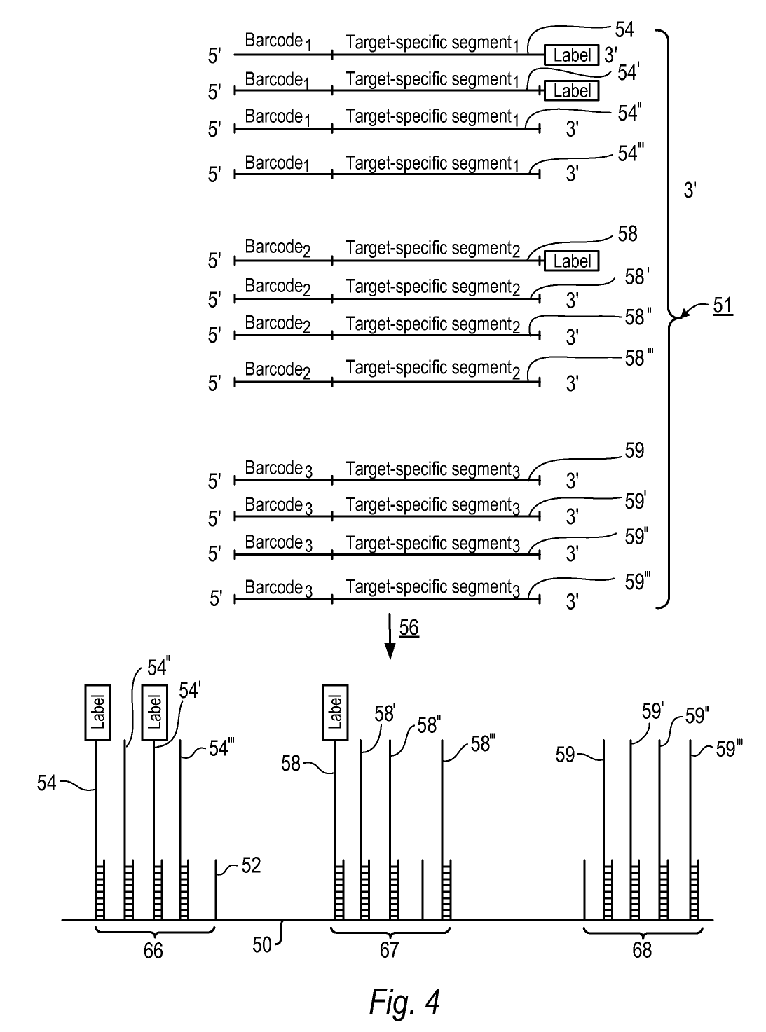

FIG. 4 illustrates the use of a mixture 51 of three different detection primers, 54, 58 and 59, obtained by the methods such as shown in FIG. 1 and simultaneously labeled such as shown in FIG. 2. Primer 54 comprises barcode₁, and target-specific segment₁, and 50% of primer 54 has been labeled. Primer 58 comprises barcode₂, and target-specific segment₂. 25% of primer 58 was labeled. For primer 59, comprising barcode₃ and target-specific segment₃, 0% was labeled. The mixture 51 of primers is hybridized at step 56 with barcode array 50. The features on array 50 comprise “antibarcode” probes that are complementary to the barcode sequences of the respective primers. For example, for antibarcode₁, probe sequence 52 is exactly complementary to barcode₁. Both of the labeled primers 54 and 54′, as well as the unlabelled primers 54″ and 54′″ are hybridized at feature 66 comprising probe sequence 52. Labeled primer 58, and unlabeled primers 58′, 58″, and 58′″ are hybridized at feature 67. Unlabeled primers 59, 59′, 59″, and 59′″ are hybridized at feature 68.

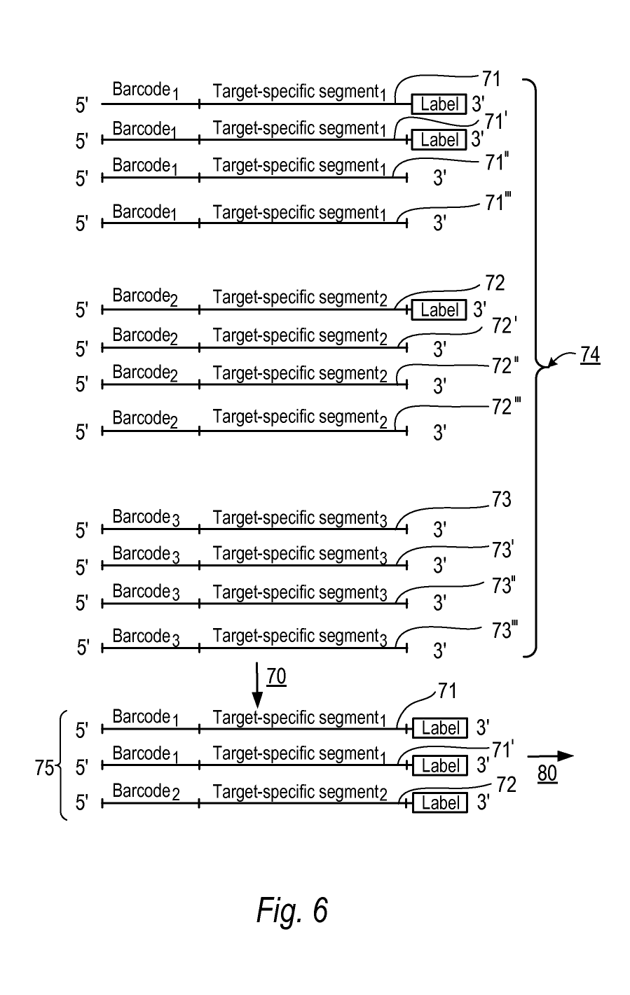

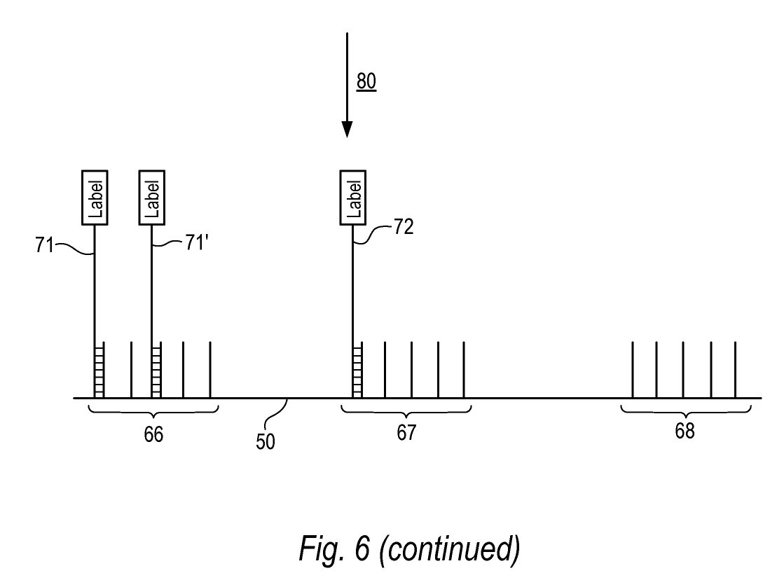

In some embodiments, a mixture of labeled, unlabeled primers, and target molecules generated as shown in FIG. 2 can be enriched for the labeled primers. As exemplified in FIG. 5, primer 60 is labeled (the label can be a detectable moiety and/or an affinity moiety) and primer 62 is unlabeled. The labeled primers are captured in step 64 using conventional enrichment methods, yielding enriched primer 60. An illustration of embodiments utilizing such enrichment procedures is shown in FIG. 6 which illustrates the use of mixture 74 obtained by the methods such as those illustrated in FIG. 1, and simultaneously labeled such as shown in FIG. 2. 50% of primer 71, which comprises barcode₁ and target-specific segment₁, has been labeled. 25% of primer 72, comprising barcode₂ and target-specific segment₂, has been labeled. None of primer 73, comprising barcode₃ and target-specific segment₃, was labeled.

Mixture 74 is enriched for labeled primers at step 70 which yields mixture 75 having twice the number of labeled primer 71 as labeled primer 72 and none of primer 73. Mixture 75 is hybridized to barcode array 50 at step 80. At feature 66, labeled primers 71 and 71′ are detected; the unlabeled primers 71″ and 71′″ were removed in step 70. At feature 67, labeled primer 72 is detected; the unlabeled primers 72′, 72″ and 72′″ were removed in step 70. At feature 68, no primer is detected; primers 73, 73′, 73″ and 73′″ were removed at step 70. Such enrichment can allow more sensitive detection due to the removal of unlabeled primers which might compete for binding to the array.

In some embodiments of the subject methods, the collections or populations of labeled primers produced by the subject methods are contacted to a plurality of different surface immobilized elements (i.e., features) under conditions such that nucleic acid hybridization to the surface immobilized elements can occur. The collections can be contacted to the surface immobilized elements either simultaneously or serially. In many embodiments the compositions are contacted with the plurality of surface immobilized elements, e.g., the array of distinct oligonucleotides of different sequence, simultaneously. Depending on how the collections or populations are labeled, the collections or populations may be contacted with the same array or different arrays, where when the collections or populations are contacted with different arrays, the different arrays are substantially, if not completely, identical to each other in terms of feature content and organization.

As used herein, a nucleotide “barcode” refers to a unique nucleotide sequence which can be used to uniquely identify each member in a collection of detection primers as described herein. Such a barcode may be any suitable length, and may be, in some embodiments, 3-200, 5-200, 8-100, or 10-50 nucleotides in length, and comprises discrete and tailorable hybridization and melting properties. In some embodiments, barcodes are designed to be heterologous to the target-specific segment of the detection primer.

By using a unique, molecular barcode for each member of a library of detection primers, a large library (e.g. a library with diversity of at least 100, 150, 200, 500, 1000, 2000, 10,000, 25,000, 10⁷, or more) can be assayed in a single container (such as a vial or a well in a plate) rather than in thousands of individual wells. This approach is more efficient and economic as it can reduce costs at all levels: reagents, plasticware, and labor.

Because each detection primer has a unique nucleotide barcode associated with its probe sequence, the amount of each of the target sequences in a mixture can be measured by measuring the amount of labeled primer for each unique target sequence. Detection primers labeled as described herein can be detected on a microarray that contains probes (antibarcode probes) complementary to the unique barcode sequences. The amount of hybridization of each labeled detection primer to its respective feature indicates the amount of the respective target sequence in the original mixture.

Simultaneous measurement of multiple (two or more) samples may performed by using different labels for each sample, where each sample has the same barcode for a given target specific segment. Alternatively, simultaneous measurement of multiple samples may be performed by using the same labels for each sample, where each sample has a different barcode for a given target specific segment. Redundant measurements may be performed for a given sample, where multiple, different barcodes may be used for the same target specific segment.

Barcode sequences may comprise minimally cross-hybridizing sets of oligonucleotide sequences, such as disclosed in U.S. Pat. No. 5,846,719; International patent publication WO 2000/058516; U.S. Pat. No. 6,458,530; Morris et al. U.S. Pat. Publication No. 2003/0104436; European patent publication 0 303 459; U.S. Pat. No. 6,709,816. The sequences of barcodes of a minimally cross-hybridizing set differ from the sequences of every other member of the same set by at least two nucleotides, and more preferably, by at least three nucleotides. Thus, each member of such a set cannot form a duplex (or triplex) with the complement of any other member with less than two mismatches, or three mismatches as the case may be. In some embodiments, perfectly matched duplexes of barcodes and barcode complements of the same minimally cross-hybridizing set have approximately the same stability, especially as measured by melting temperature. Complements of barcodes, referred to herein as “barcode complements” or “antibarcode sequences,” may comprise natural nucleotides or non-natural nucleotide analogs. In one aspect, non-natural nucleic acid analogs are used as barcode complements that remain stable under repeated washings and hybridizations of barcode sequences. Barcode complements may comprise peptide nucleic acids (PNAs). Barcodes from the same minimally cross-hybridizing set when used with their corresponding barcode complements provide a means of enhancing specificity of hybridization. Microarrays of barcode complements are available commercially, e.g., from Agilent Technologies, Santa Clara, Calif., or from Affymetrix, Santa Clara, Calif. (GenFlex™ Tag Array); and their construction and use are disclosed in, for example, International patent publication WO 2000/058516; U.S. Pat. No. 6,458,530; and U.S. Pat. Publication No. 2003/0104436.

In some embodiments, barcode complements comprise PNAs, which may be synthesized using methods disclosed in the art, such as Nielsen and Egholm (eds.), Peptide Nucleic Acids: Protocols and Applications (Horizon Scientific Press, Wymondham, UK, 1999); Matysiak et al. (2001) Biotechniques 31:896-904; Awasthi et al. (2002) Comb. Chem. High Throughput Screen. 5:253-259; U.S. Pat. No. 5,773,571; U.S. Pat. No. 5,766,855; U.S. Pat. No. 5,736,336; U.S. Pat. No. 5,714,331; U.S. Pat. No. 5,539,082; and the like. Construction and use of microarrays comprising PNA barcode complements are disclosed in Brandt et al. (2003) Nucleic Acids Research 31:e119.

In some embodiments, oligonucleotide barcodes and barcode complements are selected to have similar duplex or triplex stabilities to one another so that perfectly matched hybrids have similar or substantially identical melting temperatures. This permits mis-matched barcode complements to be more readily distinguished from perfectly matched barcode complements in the hybridization steps, e.g. by washing under stringent conditions. Guidance for carrying out such selections is provided by published techniques for selecting optimal PCR primers and calculating duplex stabilities, e.g. Rychlik et al. (1989) Nucleic Acids Research 17:8543-8551 and Rychlik et al. (1990) Nucleic Acids Research 18:6409-6412; Breslauer et al. (1986) Proc. Natl. Acad. Sci. 83:3746-3750; Wetmur (1991) Crit. Rev. Biochem. Mol. Biol. 26:227-259; and the like. A minimally cross-hybridizing set of oligonucleotides may be screened by additional criteria, such as GC-content, distribution of mismatches, theoretical melting temperature, and the like, to form a subset which is also a minimally cross-hybridizing set.

Exemplary hybridization procedures for applying labeled primers to a GenFlex™ microarray is as follows: denatured labeled primers at 95-100° C. for 10 minutes and snap cool on ice for 2-5 minutes. The microarray is pre-hybridized with 6× SSPE-T (0.9 M NaCl 60 mM Na₂PO₄, 6 mM EDTA (pH 7.4), 0.005% Triton X-100), 0.5 mg/ml of BSA for a few minutes, then hybridized with 120 μL hybridization solution at 42° C. for 2 hours on a rotisserie, at 40 RPM. Hybridization Solution consists of 3M TMACL (Tetramethylammonium Chloride), 50 mM MES ((2-[N-Morpholino]ethanesulfonic acid) Sodium Salt) (pH 6.7), 0.01% of Triton X-100, 0.1 mg/ml of Herring Sperm DNA, optionally 50 pM of fluorescein-labeled control oligonucleotide, 0.5 mg/ml of BSA (Sigma) and labeled primers in a total reaction volume of about 120 μL. The microarray is rinsed twice with 1× SSPE-T for about 10 seconds at room temperature, then washed with 1× SSPE-T for 15-20 minutes at 40° C. on a rotisserie, at 40 RPM. The microarray is then washed 10 times with 6× SSPE-T at 22° C. on a fluidic station (e.g. model FS400. Further processing steps may be required depending on the nature of the label(s) employed, e.g. direct or indirect. Microarrays containing labeled primers may be scanned on a confocal scanner (such as available commercially from Affymetrix or Agilent Technologies) with a resolution of 60-70 pixels per feature and filters and other settings as appropriate for the labels employed. GeneChip Software (Affymetrix) may be used to convert the image files into digitized files for further data analysis.

Datasets used for designing target-specific segments in detection primers as described herein can be drawn from one or more databases. Exemplary databases containing known biological sequences include the NCBI database (ncbi.nih.gov), the TIGR (The Institute for Genomic Research) gene indices (tigr.org/tdb/tgi/index.shtml), the NCBI's Unigene datasets (e.g., for H. sapiens, A thaliana, and C. elegans) (ncbi.nlm.nih.gov/entrez/query.fcgi?db=unigene), Genebank, and the USCS Genome browser website (genome.ucsc.edu). Those of skill in the art will appreciate that there are also other databases that are available and that contain additional sequences from many different organisms. Publicly available sequence databases include those maintained by: GenBank (Bethesda, Md. USA) (ncbi.nih.gov/genbank/), European Molecular Biology Laboratory's European Bioinformatics Institute (EMBL-Bank in Hinxton, UK) (ebi.ac.uk/embl/), the DNA Data Bank of Japan (Mishima, Japan) (ddbj.nig.acjp/), the Ensembl project (ensembl.org/index.html). Examples of databases that can be obtained and/or searched through the NCBI web portal (ncbi.nih.gov) include Entrez Nucleotides (including data from GenBank, RefSeq, and PDB), all divisions of GenBank, RefSeq (nucleotides), dbEST, dbGSS, dbMHC, dbSNP, dbSTS, TPA, UniSTS, PopSet, UniVec, WGS, Entrez Protein (including data from SwissProt, PIR, PRF, PDB, and translations from annotated coding regions in GenBank and RefSeq), RefSeq (proteins), and many others. Conventional techniques for primer design can be used. Exemplary references include: Rozen S, Skaletsky H (2000) Primer3 on the WWW for general users and for biologist programmers. In: Krawetz S, Misener S (eds) Bioinformatics Methods and Protocols: Methods in Molecular Biology. Humana Press, Totowa, N.J., pp 365-386; dnasoftware.com/Science/Publications/index.htm; cbi.pku.edu.cn/mirror/GenomeWeb/nuc-primer.html; SantaLucia, J., Jr. (2006) “Physical Principles and Visual-OMP Software for Optimal PCR Design”, Methods in Molecular Biology: PCR Primer Design, 2006, Anton Yuryev, Ed., Humana Press, Totowa, N.J. (2006) in press; Norman E. Watkins, Jr. and John SantaLucia, Jr. (2005) “Nearest-neighbor thermodynamics of deoxyinosine pairs in DNA duplexes”, Nucleic Acids Research 33:6258-6267; John SantaLucia, Jr. and Donald Hicks. (2004) “The Thermodynamics of DNA Structural Motifs”, Annu. Rev. Biophys. Biomol. Struct. 33:415-40.

It will be appreciated that some datasets are directed to certain types of sequence information. By way of example, some datasets are directed to genomic sequences, while other datasets are directed to expressed sequences. Still other datasets are directed to polypeptide sequences. The appropriate dataset for use will depend on both the type of array intended (CGH, expression, etc.) and the identity of the organism of interest.

In some embodiments, the target-specific segments in detection primers employed in the subject methods are at least about 6 nt in length. In some embodiments, a detection primer employed in the subject methods is one that ranges in length from about 3 to about 25 nt, from about 5 to about 20 nt, from about 10 to about 50 nt, from about 5 to about 10 nt, or from about 20 to about 200 nt (nucleotide). In some embodiments, target-specific segments in detection primers used in the present methods are devoid of indeterminate nucleotides or random sequences.

A plurality of detection primers can be designed for use in a plurality of primer extension reactions. In some embodiments, a plurality of primers (e.g., between 10 to 1 billion, 10 to 1 million, 10 to 10000 primers, between 1 to 1000 primers, between 1 to 100 primers, or between 1 to 20) can be used in the primer extension procedure. When a plurality of detection primers are used, the length and composition of each detection primer can be designed in order to minimize or substantially eliminate interference with the binding of other detection primers. For example, any cross-binding between primers or overlap of the sequences along the template can be avoided. The primers can be designed such that the target-specific segments have similar melting temperatures (e.g., within a defined range, such as 6° C.). A primer (or primers) can be designed for optimal binding during the primer extension reaction. A plurality of primers can be designed for use in simultaneous primer extensions of a plurality of different regions (such as coding regions) of a template. In some embodiments, the number of primers can range from 10 primers to 3 million primers or more.

In some embodiments, in target-specific regions in the instant detection primers are designed to bind both coding and non-coding genomic regions, (as well as regions that are transcribed but not translated), whereby coding region is meant a region of one or more exons that is transcribed into an mRNA product and from there translated into a protein product, while by non-coding region is meant any sequences outside of the exon regions, where such regions may include regulatory sequences, e.g., promoters, enhancers, introns, inter-genic regions, etc. In some embodiments, one can have at least some of the features directed to non-coding regions and others directed to coding regions. In some embodiments, one can have all of the features directed to non-coding sequences. In some embodiments, one can have all of the features directed to, i.e., corresponding to, coding sequences.

The antibarcode probes employed in the subject methods are immobilized on a solid support. Many methods for immobilizing nucleic acids on a variety of solid surfaces are known in the art. For instance, the solid surface may be a membrane, glass, plastic, or a bead. The desired component may be covalently bound or noncovalently attached through nonspecific binding.

A wide variety of organic and inorganic polymers, as well as other materials, both natural and synthetic, may be employed as the material for the solid surface. Illustrative solid surfaces include nitrocellulose, nylon, glass, diazotized membranes (paper or nylon), silicones, polyformaldehyde, cellulose, and cellulose acetate. In addition, plastics such as polyethylene, polypropylene, polystyrene, and the like can be used. Other materials which may be employed include paper, ceramics, metals, metalloids, semiconductive, materials, cermets or the like. In addition substances that form gels can be used. Such materials include proteins (e.g., gelatins), lipopolysaccharides, silicates, agarose and polyacrylamides. Where the solid surface is porous, various pore sizes may be employed depending upon the nature of the system.

Arrays comprising antibarcode probes can be fabricated using any conventional method. Non-limiting examples of such methods include drop deposition, lithographic fabrication and micromirror fabrication, as described herein.

To optimize a given assay format one of skill can determine sensitivity of fluorescence detection for different combinations of membrane type, fluorochrome, excitation and emission bands, spot size and the like. In addition, low fluorescence background membranes have been described (see, e.g., Chu et al., Electrophoresis (1992) 13:105-114).

The sensitivity for detection of spots of various diameters on an array substrate can be readily determined by, for example, spotting a dilution series of fluorescently end labeled primers. These spots are then imaged using conventional fluorescence microscopy. The sensitivity, linearity, and dynamic range achievable from the various combinations of fluorochrome and substrate can thus be determined.

Reading of the resultant hybridized array may be accomplished by illuminating the array and reading the location and intensity of resulting fluorescence at each feature of the array to detect any binding complexes on the surface of the array as described above.

Results from the reading or evaluating may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample, or whether or not a pattern indicates a particular condition of an organism from which the sample came).

### Methods for Preparing Mixtures of Detection Primers

The detection primers described above and throughout this specification may be prepared using any suitable method, such as, for example, the known, phosphotriester and phosphite triester methods, or automated embodiments thereof. In one such automated embodiment, dialkyl phosphoramidites are used as starting materials and may be synthesized as described by Beaucage et al. Tetrahedron Letters (1981) 22:1859.

In some embodiments, methods of producing pluralities of detection primers comprise array-based methods, wherein a nucleic acid array is employed as a source of the mixture of detection primers. Methods for synthesizing oligonucleotides on a modified solid support are described, e.g., in U.S. Pat. No. 4,458,066; U.S. patent application Ser. Nos. 11/831,771 and 11/284,495; and Published U.S. Application Nos. 20070037175 and 20070059692.

In some embodiments, nucleic acids comprising detection primer sequences are synthesized on a surface of a substrate, such as a flat substrate, which may be textured or treated to increase surface area. The substrate may comprise a membrane, sheet, rod, tube, cylinder, bead or other structure. In some embodiments, the substrate comprises a non-porous medium, such as a planar glass substrate. The surface of the substrate typically has, or can be chemically modified to have, reactive groups suitable for attaching organic molecules. Examples of such substrates include, but are not limited to, glass, silica, silicon, plastic, (e.g., polypropylene, polystyrene, Teflon™, polyethylimine, nylon, polyester), polyacrylamide, fiberglass, nitrocellulose, cellulose acetate, or other suitable materials. The substrate may be treated in such a way as to enhance the attachment of nucleic acid molecules. For example, a glass substrate may be treated with polylysine or silane to facilitate attachment of nucleic acid molecules. Silanization of glass surfaces for oligonucleotide applications has been described (see, Halliwell et al. (2001) Anal. Chem. 73:2476-2483). In some embodiments, the surface of the substrate to which nucleic acid molecules are attached bears chemically reactive groups, such as carboxyl, amino, hydroxyl and the like (e.g., Si—OH functionalities, such as are found on silica surfaces).

In some embodiments, an array of nucleic acids comprising detection primer sequences is subjected to cleavage conditions sufficient to cleave or separate the surface immobilized nucleic acids of the features of the array from the solid support to produce a product composition of solution phase detection primer molecules, e.g., by action of a cleavage agent, as elaborated further below.

In some embodiments, an array employed to generate a mixture of detection primers comprises a substrate having a planar surface on which is immobilized a plurality of distinct chemical features of surface immobilized nucleic acids. In some embodiments, surface immobilized single stranded nucleic acids are bound to the substrate surface by a cleavable linkage (i.e., are releasable).

In some embodiments, the surface immobilized single-stranded nucleic acids are characterized by including: (a) a variable domain (comprising a detection primer sequence); and (b) a cleavable domain, where the cleavable domain includes a region (e.g., site or sequence) that is cleavable, e.g., such that the cleavable domain serves as a cleavable linker; where the variable domain can be separated from the array surface by the cleavable domain. The cleavable domain may or may not be a constant domain, as desired. In some embodiments, the cleavable domain will be the same or identical for all of the surface-immobilized nucleic acids of the array.

In some embodiments, there are provided arrays that comprise a plurality of single-stranded nucleic acid features each comprising detection primer sequences immobilized on a surface of substrate via a cleavable linker. In some embodiments, the surface immobilized detection primer sequences are described by the formula:

surface-L-V

wherein:

L is a cleavable domain having a cleavable region; and

V is a variable domain;

where each immobilized single-stranded nucleic acid may be oriented with its 3′ or 5′ end proximal to the substrate surface and the variable domain V differs between features. The variable domain comprises a detection primer sequence as described herein.

As mentioned above, in addition to the variable domain, at least some of the surface immobilized nucleic acids present on the array includes a cleavable domain having a cleavable region. In some embodiments, cleavable linker molecules are attached to a substrate and a nucleic acid molecule is then synthesized at the end of the linker. Detection primer molecules can be harvested from an array substrate by any useful means. In some embodiments, following provision of an array, a next step is to cleave the surface immobilized nucleic acid sequences of the array features from the solid support to produce a solution phase mixture of detection primers. In this step, the array is subjected to cleavage conditions sufficient to cleave the immobilized nucleic acids of the features from the substrate surface. Generally, this step comprises contacting the array with an effective amount of a cleavage agent. The cleavage agent will, necessarily, be chosen in view of the particular nature of the cleavable region of the cleavable domain that is to be cleaved, such that the region is labile with respect to the chosen cleavage agent as described herein.

The cleavable region of the cleavable domain may be cleavable by a number of different mechanisms. In some embodiments, the cleavable domain, and particularly the cleavable region thereof, may be cleaved by light, i.e. photocleavable, chemically cleavable, or enzymatically cleavable. Photocleavable or photolabile moieties that may be incorporated into the constant domain may include, but are not limited to: o-nitroarylmethine and arylaroylmethine, as well as derivatives thereof, and the like (see, e.g., U.S. Published Patent Application Nos. 20040152905 and 20040259146).

For chemically cleavable moieties, the array can be contacted with a chemical capable of cleaving the linker, e.g. the appropriate acid or base, depending on the nature of the chemically labile moiety. Suitable cleavable sites include, but are not limited to, the following: base-cleavable sites such as esters, particularly succinates (cleavable by, for example, ammonia or trimethylamine), quaternary ammonium salts (cleavable by, for example, diisopropylamine) and urethanes (cleavable by aqueous sodium hydroxide); acid-cleavable sites such as benzyl alcohol derivatives (cleavable using trifluoroacetic acid), teicoplanin aglycone (cleavable by trifluoroacetic acid followed by base), acetals and thioacetals (also cleavable by trifluoroacetic acid), thioethers (cleavable, for example, by HF or cresol) and sulfonyls (cleavable by trifluoromethane sulfonic acid, trifluoroacetic acid, thioanisole, or the like); nucleophile-cleavable sites such as phthalamide (cleavable by substituted hydrazines), esters (cleavable by, for example, aluminum trichloride); and Weinreb amide (cleavable by lithium aluminum hydride); and other types of chemically cleavable sites, including phosphorothioate (cleavable by silver or mercuric ions) and diisopropyldialkoxysilyl (cleavable by fluoride ions). Some embodiments of chemically cleavable moieties that may be incorporated into the cleavable domain may include, but are not limited to: dialkoxysilane, β-cyano ether, amino carbamate, dithoacetal, disulfide, 3′-(S)-phosphorothioate, 5′-(S)-phosphorothioate, 3′-(N)-phosphoramidate, 5′-(N)-phosphoramidate, and ribose. Other cleavable sites will be apparent to those skilled in the art or are described in the pertinent literature and texts (e.g., Brown (1997) Contemporary Organic Synthesis 4(3):216-237; U.S. Pat. Nos. 5,700,642 and 5,830,655).

In some embodiments, a cleavable domain comprises a nucleotide cleavable by an enzyme such as nucleases, glycosylases, among others. A wide range of polynucleotide bases may be removed by DNA glycosylases, which cleaves the N-glycosylic bond between the base and deoxyribose, thus leaving an abasic site (see, e.g., Krokan et. al. (1997) Biochem. J. 325:1-16). The abasic site in a polynucleotide may then be cleaved by Endonuclease IV, leaving a free 3′-OH end. Suitable DNA glycosylases may include uracil-DNA glycosylases, G/T(U) mismatch DNA glycosylases, alkylbase-DNA glycosylases, 5-methylcytosine DNA glycosylases, adenine-specific mismatch-DNA glycosylases, oxidized pyrimidine-specific DNA glycosylases, oxidized purine-specific DNA glycosylases, EndoVIII, EndoIX, hydroxymethyl DNA glycosylases, formyluracil-DNA glycosylases, pyrimidine-dimer DNA glycosylases, among others. Cleavable base analogs are readily available synthetically. In some embodiments, a uracil may be synthetically incorporated in a polynucletide to replace a thymine, where the uracil is the cleavage site and site-specifically removed by treatment with uracil DNA glycosylase (see, e.g., Kunkel, T. A. (1985) Proc. Natl. Acad. Sci. USA 82:488-492; Lindahl (1990) Mutat. Res. 238:305-311; Published U.S. Patent Application No. 20050208538). The uracil DNA glycosylases may be from viral or plant sources, and is available commercially (e.g., Invitrogen, Catalogue no. 18054-015). The abasic site on the polynucleotide strand may then be cleaved by E. coli Endonuclease IV.

In some embodiments, to release the detection primer molecules the entire substrate can be treated with cleavage agent, or alternatively, a cleavage agent can be applied to a portion of the substrate.

In some embodiments, a silica containing solid support having nucleic acids comprising detection primer sequences immobilized on a surface thereof is subjected to cleavage conditions such that a fluid cleavage product which includes nucleic acids and silica is produced (see, e.g., Published U.S. patent application Ser. No. 11/284,495). The resultant fluid cleavage product can then purified to produce a final nucleic acid composition that includes a substantially reduced amount of silica, as compared to the fluid cleavage product.

Ammonium hydroxide can be used to harvest synthesized nucleic acid molecules from a substrate, even if the synthesized nucleic acid molecules are not attached to the substrate by a chemical bond that is cleavable using ammonium hydroxide. While not wishing to be bound by theory, the ammonium hydroxide may etch or scrape the substrate to release the synthesized nucleic acid molecules therefrom. In embodiments comprising a photocleavable linker, the linker can be cleaved by exposure to light of appropriate wavelength, such as for example, ultra violet light, to harvest the nucleic acid molecules from the substrate (see J. Olejnik and K. Rothschild, Methods Enzymol 291:135-154, 1998).

A chemical cleavage agent as described above can be contacted with the substrate for a period of time sufficient for the nucleic acids to be released from the surface of the support. Cleavage conditions can be determined empirically. In some embodiments contact is maintained for a period of time ranging from about 0.5 h to about 144 h, such as from about 2 h to about 120 h, and including from about 4 h to about 72 h. Any convenient method may be used to contact the cleavage agent with the nucleic acid displaying substrate. For instance, contacting may include, but is not limited to: submerging, flooding, rinsing, spraying, etc. Contact may be carried out at any convenient temperature, where in representative embodiments contact is carried out at temperatures ranging from about 0° C. to about 60° C., including from about 20° C. to about 40° C., such as from about 20° C. to about 30° C.

The resultant fluid cleavage product can be purified to obtain a purified composition of solution phase detection primer molecules.

In some embodiments, a cleavable linker phosphoramidite can be added to the 5′-terminal OH end of a support-bound oligonucleotide to introduce a cleavable linkage. Multiple nucleic acids of the same or different sequence, linked end-to-end in tandem, can be synthesized by further incorporation of cleavable building block, and nucleic acid synthesis prior to cleavage from the substrate (see, e.g., Pon et al. (2005) Nucleic Acids Res. 33:1940-1948; U.S. Published Patent Application Nos. 20030036066 and 20030129593).

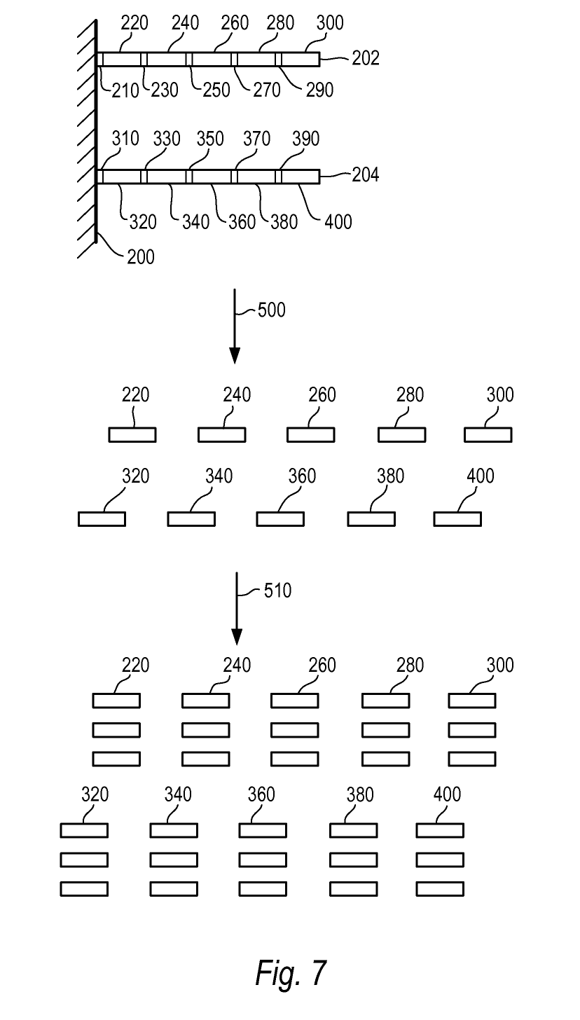

FIG. 7 illustrates some embodiments of methods for producing detection primers. Single-stranded nucleic acids 202 and 204 are attached to substrate 200. Nucleic acid 202 comprises variable domains 220, 240, 260, 280 and 300, and cleavable domains 210, 230, 250, 270 and 290. Nucleic acid 204 comprises variable domains 320, 340, 360, 380 and 400, and cleavable domains 310, 330, 350, 370, and 390. Each variable domain can comprise the sequence of a detection primer. For nucleic acid 202 (and likewise, for nucleic acid 204) the sequences of the variable domains can be the same or different from each other. In step 500, a cleavage agent (not shown) cleaves the cleavable domains of nucleic acid 202 and nucleic acid 204 releasing the variable domain nucleic acids as shown. In optional step 510, released variable domain nucleic acids can be amplified using amplification primers (not shown).

In some embodiments, the multiple variable domain nucleic acids prepared can be simultaneously released from each other and from the surface of the support when treated with a single cleavable agent. In some embodiments, the cleavable domains (such as shown in FIG. 7) may or may not all be the same. In some embodiments, use of different cleavable domains between the variable domains can allow selective and sequential release of the products from the support by adjusting the cleavage conditions for each particular cleavable domain.

The above-described methods result in the production of a plurality of solution phase detection primers, where each of the different variable domains of the precursor array is represented in the plurality, i.e., for each feature present on the template array, there is at least one nucleic acid in the product plurality that corresponds to the feature, where by corresponds is meant that the nucleic acid is one that is generated by cleavage of a surface immobilized detection primer sequence of the feature of the array.

In some embodiments, the amount or copy number of each distinct nucleic acid of differing sequence in the product plurality is known. The amounts of each distinct nucleic acid in the product plurality may be equimolar or non-equimolar, and can be conveniently chosen and controlled by employing a precursor array with the desired number of features (as well as molecules per/feature) for each member of the plurality. For example, where a product plurality that is equimolar for each member nucleic acid is desired, a precursor array with the same number of features for each member nucleic acid is employed. Alternatively, where a product plurality is desired in which there are twice as many nucleic acids of a first sequence as compared to a second sequence, a precursor array that has two times as many features of the first sequence as compared to the second sequence may be employed.

Constituent members of the plurality of detection primers can be, in certain embodiments, physically separated, such as present on different locations of a solid support (e.g., of the precursor array), present in different containment structures, and the like.

The arrays employed may be generated de novo or obtained as a pre-made array from a commercial source, where in either case the array will have the characteristics described herein (see, e.g., U.S. Pat. Nos. 6,656,740; 6,613,893; 6,599,693; 6,589,739; 6,587,579; 6,420,180; 6,387,636; 6,309,875; 6,232,072; 6,221,653; and 6,180,351).

Detection primers prepared as described herein may optionally be amplified using any suitable method. A large variety of polynucleotide amplification reactions known to those skilled in the art may be used. The most common form of polynucleotide amplification reaction, such as a PCR reaction, is typically carried out by placing a mixture of target nucleic acid sequence, deoxynucleotide triphosphates, buffer, two primers, and DNA polymerase in a thermocycler which cycles between temperatures for denaturation, annealing, and extension (PCR Technology: Principles and Applications for DNA Amplification (ed. H. A. Erlich, Freeman Press, NY, N.Y., 1992), PCR Protocols: A Guide to Methods and Applications (eds. Innis, et al., Academic Press, San Diego, Calif., 1990), Mattila et al., Nucleic Acids Res. 19:4967 (1991), Eckert et al., PCR Methods and Applications 1, 17 (1991), PCR A Practical Approach and PCR2 A Practional Approach (eds. McPherson et al., Oxford University Press, Oxford, 1991 and 1995), all incorporated by reference). The selection of amplification primers defines the region to be amplified. The polymerase used to direct the nucleotide synthesis may include, for example, E. coli DNA polymerase I, Klenow fragment of E. coli DNA polymerase, polymerase muteins, heat-stable enzymes, such as Taq polymerase, Vent polymerase, and the like.

Amplification primers (PCR primers) that are complementary to at least a portion of the nucleic acids that are to be amplified (prior to or after release) can be used to prime a polymerase chain reaction. For example, in some embodiments, a PCR primer hybridizes to a 5′ binding region of the nucleic acid molecule to be amplified, and the same PCR primer, or a different PCR primer, hybridizes to a 3′ binding region of the nucleic acid molecule to be amplified. PCR primers, preferably range in length from about 4 to about 30 nucleotides. Computer programs are useful in the design of PCR primers with the required specificity and optimal amplification properties (e.g., Oligo Version 5.0 (National Biosciences)).

The amplification primers may be modified by labeling with an affinity moiety (affinity tag) and/or a detector moiety (e.g., enzyme). In certain aspects, the amplification products will comprise an affinity moiety, and the nucleic acid product or products can be purified using the affinity moiety. Suitable affinity moieties are exemplified by biotin, avidin and streptavidin or naturally or synthetic variants or homologs thereof. PCR amplification products can be purified using any suitable means. For example, such means include gel electrophoresis, column chromatography, high pressure liquid chromatography (HPLC) or physical means such as mass spectroscopy.

### Kits

Also provided are kits for use in the subject methods, where such kits may comprise containers, each with one or more of the various reagents (typically in concentrated form) utilized in the methods, where such reagents include, but are not limited, the subject detection primers, buffers, nucleotide triphosphates (e.g. dATP, dCTP, dGTP, dTTP), chain terminators (e.g., dideoxy nucleotide triphosphates), polymerase, labeling reagents, labeled nucleotides, nucleic acid standards used for methods calibration, and the like. Where the kits are specifically designed for use in some embodiments, the kits may further include labeling reagents for making two or more collections of distinguishably labeled detection primer populations. Kits can comprise an array of antibarcode probes as described herein, hybridization solutions, etc.

In some embodiments, kits that may comprise: (a) an array for producing detection primers as described herein; and (b) a cleavage agent for cleaving a cleavable domain as described herein.

The kits may further include instructions for using the kit components in the subject methods. The instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc.

The above disclosure demonstrates that novel methods of producing labeled detection primers from template nucleic acid is provided, where an advantage of the subject methods include the feature that the produced populations are less complex than populations produced by other methods, such as nick translation or random primer extension, and are therefore more suitable for use with immobilized probe array based applications. As such, the subject methods represent a significant contribution to the art.

Although the foregoing has been described in some detail by way of illustration and example for purposes of clarity of understanding, it is readily apparent to those of ordinary skill in the art in light of the teachings of this disclosure that certain changes and modifications may be made thereto without departing from the spirit or scope of the appended claims.

What is claimed is:

1. A method for evaluating a mixture of polynucleotides, the method comprising:
contacting a mixture of polynucleotides with a plurality of unique detection primers under hybridization conditions, wherein each of said primers comprises a target-specific segment complementary to a respective sequence of interest in said polynucleotide, 3′-end labeling said primers, and
analyzing the labeled primers.

2. The method of claim 1 wherein each member of said plurality of detection primers comprises a unique 5′ barcode sequence.

3. The method of claim 1 comprising affinity purifying said labeled primers, and wherein said analyzing comprises sequencing at least some of said primers.

4. The method of claim 2 wherein said analyzing comprises quantifying the amount of at least some of said polynucleotides.

5. The method of claim 2 wherein said labeling comprises contacting said mixture with a plurality of said primers under conditions to incorporate a detectable moiety and/or a affinity moiety into the 3′ end of said detection primers.

6. The method of claim 2 wherein said labeling comprises a template-dependent extension reaction.

7. The method of claim 2 comprising enriching labeled primers hybridized to said polynucleotides prior to said analyzing.

8. The method of claim 7 wherein said enriching comprises affinity purification.

9. The method of claim 7 wherein said analyzing comprises sequencing at least some of said polynucleotides.

10. The method of claim 7 wherein said enriching comprises enzymatic digestion of unlabeled detection primers.

11. The method of claim 2 wherein said analyzing comprises:
contacting hybridized primers with an array, said array comprising a plurality of unique features, wherein each said unique barcode sequence is complementary to a respective unique feature of said array, and
determining binding between said unique features and said primers.

12. The method of claim 2 wherein said plurality of detection primers is obtained by an array-based method.

13. The method of claim 12 wherein said array-based method comprises:
providing an array comprising sequences comprising said detection primers immobilized on a surface of a solid support via a cleavable domain comprising a cleavable region, and
cleaving the cleavable region.

14. The method of claim 13 comprising amplifying said plurality of detection primers after said cleaving.

15. The method of claim 14 comprising shortening a detection primer after amplification, resulting in a shortened detection primer with a free 3′-hydroxyl.

16. The method of claim 13 wherein said array comprises a plurality of nucleic acid molecules each comprising nucleic acid segments arranged end-to-end, said segments separated from each other by cleavable regions, wherein each of said segments comprises the sequence of one of said unique detection primers.

17. The method of claim 1 wherein the sequences of the target-specific regions of said detection primers are selected based on the known sequence of said polynucleotides.

18. A method for evaluating a polynucleotide, the method comprising:
subjecting a polynucleotide to cleavage conditions to form a mixture of cleaved polynucleotides,
contacting said mixture with a plurality of unique detection primers under hybridization conditions, wherein each unique detection primer in said plurality comprises a target-specific segment complementary to a sequence of interest in said polynucleotide, 3′-end labeling hybridized detection primers by template-dependent primer extension, wherein said plurality of detection primers is obtained by an array-based method, and,
analyzing the labeled detection primers.

19. A kit for use in evaluating a mixture of polynucleotides, the kit comprising:
a) a plurality of unique detection primers capable of hybridizing to at least some of said polynucleotides, wherein each unique primer comprises a unique 5′ barcode sequence, and'
b) means for 3′-end labeling said detection primers.

20. A kit of claim 19 wherein said label comprises an affinity tag, and wherein said kit further comprises an affinity medium for binding said affinity tag.

21. The kit of claim 19 further comprising an array, wherein said array comprises a plurality of unique antibarcode features, wherein each unique barcode sequence is complementary to a respective unique antibarcode feature of said array.
